(19) United States
(12) Patent Application Publication
(10) Pub. No.: US 2009/0220665 A1
(43) Pub. Date: Sep. 3, 2009

(54) Citrus fruit fibers in processed meat

(76) Inventors: Jozef Guido Roza Vanhemelrijck, Meise (BE); John Van De Sype, Semmerzake (BE)

Correspondence Address: FISH & RICHARDSON P.C., PO BOX 1022, MINNEAPOLIS, MN, 55440-1022, US

(21) Appl. No.: 11/914,715

(22) PCT Filed: May 15, 2006
(86) PCT No.: PCT/EP06/04538

§ 371 Date: Apr. 2, 2009

(30) Foreign Application Priority Data
May 18, 2005 (EP) 05253044.1

(51) Int. Cl. A23J 1/14; A23J 3/16; A23L 1/317

(52) U.S. Cl. 426/550; 426/574; 426/656

(57) ABSTRACT

The current invention relates to a mixture of citrus fruit fibers and soy protein flour, use of such mixtures in processed meat and to increase the functionality of soy protein flour.

### TECHNICAL FIELD

The current invention relates to a composition of citrus fruit fibers and soy protein, and its use in processed meat.

### BACKGROUND OF THE INVENTION

Food manufacturers are continuously challenged to find ways to present an appetizing and authentic food product at minimized raw material costs. One area of particular endeavor has been the goal of producing attractive meat-based products.

It is well known that meat-analogues can be prepared from meat by-products such as liver, lungs and other trims with binders.

WO 2004/045301 relates to a proteinaceous meat analogue that is particularly useful in packaged pet foods. This meat analogue contains from 40 to 95-wt % edible proteinaceous material extracted from meat of bovine or of ovine, then a predetermined mixture of inter alia soy flour, soy meal, and soy concentrate is added. This mix of proteins is highly functional as it contains protein extract and soy concentrate.

Indeed, soy protein concentrates contain at least 65-wt % of protein. The use of such kind of concentrate is necessary in order to obtain a suitable texture.

U.S. Pat. No. 6,039,952 pertains to a pet food composition comprising crude proteins and dietary fibers. Here also the process involves crude proteins, especially soy protein isolate which are interesting on a nutritional point of view and texturizing point of view. Indeed, these isolates contain at least 90-wt % of proteins and thus are highly functional.

US 2001/0033856 aims at a food composition in flour form comprising at least 50-wt % of protein and 35 to 50-wt % of plant fibers. This composition is used as a substitute for wheat flour in the preparation of foods such as pasta, bread, bread sticks or bakery product. The proteins used in this composition are inter alia soya proteins obtained from soya bean protein (soy protein isolates).

As it is apparent from the art, some attempts have been made to prepare meat analogue by using soy proteins. Nevertheless, the known processes always involve highly functional soya fraction. Indeed, the more the fraction used is concentrated in proteins, the more it will be functional in terms of texturizing properties, water binding properties, and emulsifying properties. These properties are necessary to produce a product without fat separation or syneresis. The drawback of such material is the cost because the proteins are the expensive part of the soy mixtures.

Thus, there is currently still a need for obtaining processed meat prepared from protein having an inferior functionality.

The current invention provides such a product and process for preparing it.

### SUMMARY OF THE INVENTION

The current invention relates to a composition comprising dried citrus fruit fiber and soy protein flour. The citrus fruit fiber is having a total dietary fiber content of from 60 to 85-wt % and a water binding capacity of from 7 to 25 (w/w).

In one embodiment, dried citrus fiber has a total dietary fiber content of from 60 to 80-wt % and a water binding capacity of from 7 to 12 (w/w).

In a preferred embodiment, the invention is a dry composition.

Furthermore the citrus fruit fiber is obtainable from citrus fruit selected from the group consisting of oranges, tangerines, limes, lemons and grapefruit.

The dry weight ratio of the dried citrus fruit fiber to protein is from 1:99 to 99:1, preferably from 5:95 to 90:10, more preferably from 10:90 to 30:70.

The composition can optionally further comprise hydrocolloids.

The current invention relates also to a liquid composition comprising the dry composition of the current invention and an edible liquid. The edible liquid is water, water-based liquid, water-miscible liquids and/or mixtures thereof.

Furthermore the invention relates to a meat emulsion comprising the dry composition according to the current invention, fat and water in a weight ratio up to 1:7:7, preferably from 1:4:4 to 1:7:7, more preferably 1:5:5 of dry composition:fat:water.

The current invention relates to the use of dried citrus fruit fiber to increase functionality of soy protein flour. Finally, said functionality is increased in processed meat.

The current invention relates to processed meat comprising edible ingredients and a composition or a meat emulsion according to the current invention.

Furthermore it relates to a process for preparing processed meat and said process comprises the following steps:
a) adding to meat the dry composition according to current invention to water, or taking liquid composition of current invention,
b) adding fat,
c) optionally adding salt,
d) optionally adding further edible ingredients,
e) mixing,
f) optionally casing the processed meat.

### DETAILED DESCRIPTION

The current invention relates to a composition comprising dried citrus fruit fiber and soy protein flour. Citrus fiber is a valuable component, which has relatively high total dietary fiber content and a balanced ratio of soluble to insoluble dietary fiber. For example, the total dietary fiber preferably is made up of about 45-50% soluble dietary fiber and from 50-55% insoluble dietary fiber.

The balanced dietary fiber spectrum insoluble (structural) and soluble (chiefly pectin) fiber is advantageous in physiological functionality over cereal-based fibers. Citrus fiber of the present invention, particularly orange fiber, has an extremely high water binding capacity, resulting in high viscosities compared to Vitacel™ orange fiber (available from Rettenmaier). In one preferred embodiment, dried citrus fiber has a total dietary content of from about 60 to about 85-wt % (based on dry substance) and a water binding capacity of from 7 to about 25 (w/w). Preferably the total dietary fiber content is at least about 70-wt % and the water binding capacity is at least about 8 (w/w).

The citrus fiber is extracted from citrus vesicles from a wide variety of citrus fruits, non-limiting examples of which include oranges, tangerines, limes, lemons and grapefruit.

Citrus vesicles refer to the cellulosic material contained in the inner, juice-containing portion of citrus fruit. Citrus vesicles are sometimes also referred to as coarse pulp, floaters, citrus cells, floating pulp or pulp.

In contrast, citrus flour obtained from citrus peel is characterized by an orange peel taste and odor, and a dark orange color, which is severely limiting the product's uses. Additional advantages of citrus fiber versus citrus flour are a higher total dietary fiber content (e.g., about 72-wt % versus 58-wt %); lower carbohydrate content (e.g., about 5-wt % versus 15-wt %); and higher water binding (e.g., greater than about 8.5 grams of water per gram of fiber versus 5.5 g/g). The protein content of the citrus fiber typically ranges from about 8 to 12 wy-%.

The ratio soluble to insoluble dietary fiber is an important factor in the citrus fiber's functionality. Other important considerations include the degree of milling (granulometry) and drying conditions (process of drying). Generally, a higher degree of milling (i.e., a finer fiber granulometry) results in more smoothness of the fiber in the solution, as well as reduced water absorption capacity and reduced oil binding capacity compared to coarse fibers. Preferably dried citrus fruit fiber is obtainable according to the process disclosed in the pending WO patent application 2006/033697.

The current invention relates to a composition wherein the soy protein is soy protein flour.

Soy protein flour, including grits, is made by grinding and screening soybean flakes either before or after removal of the oil. Its protein content is in the range of 37 to 54-wt %.

Soy flours and grits are the least refined forms of soy protein products used for human consumption and may vary in fat content, particle size, and degree of heat treatment. They are also produced in lecithinated or defatted forms. The degree of heat treatment creates varying levels of water dispersibility and enzyme activity qualities that can be useful in tailoring functionality in many food applications.

The soy protein flour according to the invention contains up to 54-wt % of protein, preferably from 37 to 54 wt-%.

When defatted soy protein flour is used, the content of proteins is preferably between 49 and 54-wt %; when full-fat soy flour is used, the protein content is preferably from 37 to 42 wt-%, otherwise, it contains preferably from 42 to 49-wt % of protein.

If necessary, the soy protein flour can optionally be mixed with another source of protein in order to increase the protein content in the application.

Soy protein flour has a limited functionality in terms of emulsifying ability and water-binding property. However blending the soy protein flour with dried citrus fruit fiber, in particular the dried citrus fruit fiber obtainable according to the process from the application WO2006/033697, improves its functionality and particularly its emulsifying ability and/or water binding capacity in order to avoid fat and/or jelly separation when used in the manufacture of processed meat for example.

In another embodiment, the composition further comprises hydrocolloids. Examples of hydrocolloids include carrageenan, xanthan, guar, locust bean, alginates, carboxymethylcellulose, carob bean gum, starch derivatives (native and/or modified starches, maltodextrins, and the like), where present, the amount of hydrocolloids is up to 30% w/w on the dry composition.

Conventionally, starch hydrolysates with DE up to 20 are termed maltodextrins.

The current invention further discloses liquid composition comprising the dry compositions of the current invention and an edible liquid. The edible liquid can be selected from water, water-based liquids such as milk, water-miscible liquids such as lower alcohols like ethanol and/or mixtures thereof.

Furthermore the current invention relates to a meat emulsion comprising the dry composition according to current invention, fat and water in a weight ratio up to 1:7:7, preferably from 1:4:4 to 1:7:7, more preferably 1:5:5 dry composition:fat:water. All the weight ratios up to 1:7:7 (dry composition:fat:water) wherein the dry composition is preferably comprising soy protein flour are resulting in suitable meat emulsions. Weight ratios such as 1:1:1, 1:2:2, 1:3:3, 1:4:4, 1:5:5, 1:6:6 and 1:7:7 of dry composition:fat:water are all part of the current invention.

Meat emulsion systems are often used in the meat industry to predict performance of proteins or other functional ingredients in processed meats such as sausages, pâté and the like.

The meat emulsions are prepared as follows: after adding the dry composition of the current invention to the water, the suspension is chopped until smooth and shiny appearance in e.g. a bowl cutter.

After adding the fat, the complete mixture is emulsified and optionally some salt is added followed by increasing the temperature.

These model emulsions are evaluates for fat/jelly separation (visual) and hardness (Texture analysis by TPA penetration with small ebonite plunger of 314 mm² area for 20 mm penetration distance into the emulsified product. Test temperature is refrigerator temperature). Ideally, the pasteurized or sterilized model emulsion product should show no jelly and/or fat separation, and as high firmness as possible.

The current invention relates to processed meat comprising edible ingredients and a composition or a meat emulsion according to the current invention.

Processed meat is including for example emulsified cooked meat products and grounded meat products. It may include half-processed meat, ham, bacon, sausage, corned beef, dried meat, meat dumpling, hamburger, meatballs, raw shao-mai, daily household dishes and the like.

Ham further includes roasted meat, preserved chicken and fresh ham. The sausage can be smoked or dried. Further subdivision of hamburger and/or meatballs can be made according to the content of meat, being more or less than 50% of meat content. The food items referred to as daily household dishes, regardless of actual meat content, include pork cutlets, Japanese soup broth, shao-mai, croquette and wontons.

Edible ingredients of processed meat are meat-based products, and additives.

Typical additives for processed meat are nitrite-salts, phosphates, pepper, macis, gember, Cardemom, ascorbic acid, mono sodium glutamate and the like.

The current invention has demonstrated that by applying the composition of the current invention in processed meat the fat and the jelly separation are significantly reduced (and or none existing) and the firmness is increased. By applying the composition of the current invention in the preparation of hamburger there is no shrinking observed and the yield is the same. Furthermore the dry composition has a high water-holding capacity even with a low content of meat.

Sausage comprising the composition of the current invention can be cased in permeable or impermeable casings.

The composition of the current invention is suitable for the use in processed meat. Furthermore it relates to a process for preparing processed meat and said process comprises the following steps:
a) adding to meat the dry composition according to current invention to water, or taking liquid composition of current invention,
b) adding fat,
c) optionally adding salt,
d) optionally adding further edible ingredients,
e) mixing,
f) optionally casing the processed meat.

The current invention demonstrates the following advantages:
Compositions of citrus fruit fiber and soy protein can be prepared in any ratio.
The citrus fruit fiber improves the functionality of soy protein flour in terms of emulsifying properties and/or water binding capacity.
Protein of lower quality, such as soy protein flour can be used in processed meat and no jelly/fat separation is observed and meat products of good quality are obtained.
The dry composition of the current invention can be used in any weight ratio with fat and water to study the jelly fat separation in meat emulsions.

The invention is further defined by reference to the following examples describing in detail the preparation of the composition of the present invention. The invention described and claimed herein is not to be limited in scope by the specific embodiments herein disclosed, since these embodiments are intended as illustrations of several aspects of the invention. Any equivalent embodiments are intended to be within the scope of this invention. Indeed, various modifications of the invention in addition to those shown and described herein will become apparent to those skilled in the art from the foregoing description. Such modifications are also intended to fall within the scope of the appended claims.

### EXAMPLES

The citrus fruit fibers used in the following examples were Orange Pulp Fibers (OPF) obtained by the process disclosed in WO 2006/033697. The orange pulp fibers from examples 1 to 3 have a water binding capacity of from 7 to 12.

### Example 1

### Meat emulsion

1/4/4 emulsions were based on 1 part dry composition/4 parts of fat and 4 parts of water. 1/5/5 emulsions were based upon 1 part dry composition/5 parts of fat and 5 parts of water. The following compositions of the current invention were used as dry composition in the emulsion:

10% coarse orange fiber (+90% defatted soy flour (10 mesh-80 PDI from Cargill)
20% coarse orange fiber (+80% defatted soy flour (10 mesh-80 PDI from Cargill)
30% coarse orange fiber (+70% defatted soy flour (10 mesh-80 PDI from Cargill)

Coarse orange fiber granulometry: average particle size of 500 microns as measured with Sympatec Laser PSD Instrument.

PDI=protein dispersibility index

The emulsion was formed as follows:

350 grams of dry composition was added onto a water/ice cubes blend (700 grams water/700 grams of ice) and mixed for 3 minutes at speed 1 (slow speed) in a Stephan electronic 2010 UMOL lab cutter. Back fat (1400 grams) was added and cuttered for 2 minutes at speed 2. Salt (47.25 gram) was added and the cutter procedure at speed 2 was continued until 17° C. was reached. 5 cans were filled with the model emulsion product.

Cutter procedure was then further continued until 24° C. and again 5 cans were filled. All can were closed.

A part of the cans was then pasteurized in water bath at 80° C. until core temperature of 72° C. was reached.

Another part of the cans was sterilized for 20 minutes at 121° C. in a lab sterilizer unit.

After the respective heat treatments, the cans were cooled down as fast as possible into cold ice water and stored at 4° C.

The obtained results are displayed in Table 1.

TABLE 1

| | Emulsion | Jelly | Hardness TAXT2 |
|---|---|---|---|
| Dry composition | type | separation | Plus (grams) |
| SF 200-70 90% OPF 10% | 1P 4W 4F | None | 457 |
| | (past.) | | |
| SF 200-70 80% OPF 20% | 1P 4W 4F | None | 714 |
| | (past.) | | |
| SF 200-70 70% OPF 30% | 1P 5W 5F | None | 367 |
| SF 200-70 80% OPF 15% | 1P 5W 5F | None | 1150 |
| 5% Carrageenan K200 | | | |

SF 200-70 = defatted Soy flour (Cargill) (200 mesh - 70 PDI (protein dispersibility index)
OPF = orange fiber (Cargill)
SF 200-70 90% OPF 10% = 90% (w/w) of defatted soy flour 200 mesh - 70 PDI) and 10% (w/w) orange fiber (Cargill)
1P 4W 4F = 1 part dry composition/4 parts water/4 parts fat
1P 5W 5F = 1 part dry composition/5 parts water/5 parts fat

The jelly separation was based upon visual observation.

The hardness was measured with Texture analyzer (Texture analysis by TPA penetration with small ebonite plunger of 314 mm² area for 20 mm penetration distance and at penetration test speed of Immi/second into the emulsified product. Test temperature is refrigerator temperature).

Fat and jelly separations were reduced and firmness of the resulting 1/4/4 meat emulsion system was increased.

### Example 2

The following recipes were applied:

TABLE 2
Beef burger

| Beefburger | Reference | C 1 | C 2 |
|---|---|---|---|
| Beef | 98.50% | 80% | 70% |
| Spices | 1.50% | 1.50% | 1.50% |
| Prosanté hydrated (texturised | | 10% | 15% |
| defatted soy protein flour (Cargill) | | | |
| Coarse OPF Fiber (Cargill) | | 0.76% | |
| (granulometry: average particle | | | |
| size 500 microns) | | | |
| Fine OPF Fiber (Cargill) | | | 1.21% |
| (granulometry: average particle | | | |
| size 100 microns) | | | |
| Water | | 7.74% | 12.29% |
| Total | 100.00% | 100% | 100% |

The beefburgers were prepared as follows:

Grinded beef meat, soy protein flour and orange fiber were blended with water in Hobart mixer Type N50CE at speed 1 and after 30″ spices were added.

After 2.5 min. the mass was turned manually; the mass was further blended for total time of 5 minutes.

The blend was put in refrigerator for 2 hours.

The burgers of 90 grams were formed using a cylindrical burger former device KD1 with inner diameter of 83 mm. After forming, the burgers were then fried fresh until 74-75° C. core temperature.

The quality of the products was determined by the following parameters:
Measurements of dimensions before and after frying: shrinkage
Measurement of cooking loss (weight before and after frying)
Taste, texture and juiciness, aspect and color

$$Yield = 100 \% - \{ \frac{( weight start - weight after baking )}{( weight start )} \} * 100$$

weight start=weight of burger before baking
Shrink=diameter before baking minus diameter after baking.

The following observations were made:

TABLE 3

| Beefburger | Reference | C 1 | C 2 |
|---|---|---|---|
| Before Baking | | | |
| Diameter (mm) | 80 | 80 | 80 |
| Height (mm) | 20 | 20 | 20 |
| After Baking | | | |
| Diameter (mm) | 65 | 65 | 65 |
| Height (mm) | 20 | 20 | 17 |
| Shrink (mm) | 15 | 15 | 15 |
| Yield % | 83 | 81 | 83 |
| Beef % | 98.5 | 80 | 70 |
| water % | 0 | 15 | 23 |

There is no difference in shrink between the reference and the products of the current invention. Also the yield is the same between the reference and the products of the current invention.

### Example 3

TABLE 4
Sausage

| Sausage | Reference | C 1 |
|---|---|---|
| Pork Meat SI (20% fat) | 40% | 27% |
| Pork fat (55% fat) | 30% | 31% |
| Backfat (90% fat) | 10% | 0% |
| Ice | 20% | 38% |
| Fine OPF Fiber Cargill) | | 1.20% |
| Soy flour 70 PDI (Cargill) | | 2.80% |
| | 100% | 100% |

Pork meat SI=(20% fat-17% protein-63% water)
Pork fat=(55% fat-10% protein-35% water)
Back fat=(90% fat-2% protein-8% water)
   Fine OPF Fiber (Cargill) (granulometry: average particle size 100 microns

On 10 kg meat basis the following additives were added:
200 grams Nitrite salt
30 grams Phosphate
37 grams Spice blend
10 gram MSG (mono sodium glutamate)
10 gram ascorbic acid

The sausages were prepared as follows:

First Cutter (slow speed):
Add pork meat
Add salt and phosphate
⅓ of ice and spices
the total was cuttered to 6° C. followed by cuttering at high speed.
Add orange fiber and soy protein flour+⅓ ice
Add back fat and cutter to 12° C.
Add ⅓ of ice+ascorbic acid
Cutter to 14° C.

The end-products were stuffed into casings using Stephan continuous vacuum filler
3 sausages into sterile, non-permeable casing (diameter 6 cm)
3 sausages into permeable natural sheep casing (diameter 6 cm)

The cased meat was cooked in water at 75-80° C. until core temperature sausage of was 72° C.

Finally after cooking the sausages were cooled in ice water.

The products were analyzed visually for color and fat/jelly separation and further by Texture Analysis (TAXT2 Plus):
Cutting test (blade knife test)

A cutting blade (10 cm long sharp cutting edge width 7 cm) was mounted on the moving upper part of the texture analyzer.

A 28 mm thick slice of sausage (diameter 6 cm) was cut with the cutting blade and the maximum cutting force (grams) was recorded.

Finally the cooking loss (only on sausages stuffed into permeable casings) was determined by weighting the sausage before and after the cooking process. For yield, the same formula as shown in the beef burger example was used.

TABLE 5

| | |
|---|---|
| Reference | C 1 |

After cooking Permeable casings

| | | |
|---|---|---|
| Fat Jelly separation | none | none |
| Hardness (cutting test TAXT2) | 2200 | 1800 |
| Yield % | 94 | 95 |

After cooking Non-Permeable casings

| | | |
|---|---|---|
| Fat Jelly separation | none | none |
| Hardness (cutting test TAXT2) | 1980 | 1725 |
| Taste/mouthfeel | Standard | Standard |

### Example 4

The water binding capacity of the citrus fibers suitable to be used according to the invention was measured.

3 samples were ground at different granulometry (40 μm, 75 μm, and, 250 μm) and then weighted with a precision balance Sartorius CP 3245. Each sample was prepared in double and an average was made to give the final result.

The procedure was as follow:
In a 50 ml centrifuge tube, 0.5 g of the fiber (dry powder) was weighted (W1),
40 g milli-Q water was added. The weight of the water was noted (W2),
The tube was closed and stirred during 1 min by hand,
The tube was then submitted to a centrifugation during 5 min at 2000 rpm with the centrifuge Labofuge 400 Heraeus,
The supernatant was decanted and weighted (W3).

The water binding capacity (WBC) is expressed as g water/g sample:

WBC=(W2−W3)/W1

TABLE 6

| | WATER BINDNG |
|---|---|
| | CAPACITY |
| SAMPLES | g water/g product |
| OPF 40 μm | 19.01 |
| OPF 75 μm | 19.19 |
| OPF 250 μm | 24.14 |

1. A composition comprising dried citrus fruit fiber and soy protein flour.

2. A composition according to claim 1 wherein said composition is dry.

3. A composition according to claim 1, characterized in that the citrus fruit fiber is having a total dietary fiber content of from 60 to 85-wt % and a water binding capacity of from 7 to 25 (w/w).

4. A composition according to claim 1 characterized in that the citrus fruit fiber is having a total dietary fiber content of from 60 to 80-wt % and a water binding capacity of from 7 to 12 (w/w).

5. A composition according to claim 1, characterized in that the citrus fruit fiber is obtainable from citrus fruit selected from the group consisting of oranges, tangerines, limes, lemons, and grapefruit.

6. A composition according to claim 1 characterized in that the weight ratio of dried citrus fruit fiber to protein is from 1:99 to 99:1.

7. A composition according to claim 1, characterized in that the composition further comprises hydrocolloids.

8. A liquid composition comprising the dry composition according to claim 2 and an edible liquid.

9. A liquid composition according to claim 8 characterized in that the edible liquid is water, water-based liquids, water miscible liquids and/or mixtures thereof.

10. A meat emulsion comprising the dry composition according to claim 2, fat and water in a weight ratio up to 1:7:7 dry composition:fat:water.

11. (canceled)

12. (canceled)

13. (canceled)

14. Processed meat comprising edible ingredients and a composition according to claim 2 or a meat emulsion according to claim 10.

15. A process for preparing processed meat, wherein said process comprises the following steps:
a) adding, to meat, the dry composition according to claim 2 and water, or the liquid composition of claim 8 or 9,
b) adding fat,
c) optionally adding salt,
d) optionally adding further edible ingredients,
e) mixing,
f) optionally casing the processed meat.

16. A composition according to claim 1, characterized in that the weight ratio of dried citrus fruit fiber to protein is from 5:95 to 90:10.

17. A composition according to claim 1, characterized in that the weight ratio of dried citrus fruit fiber to protein is from 10:90 to 30:70

18. A meat emulsion comprising the dry composition according to claim 2, fat and water in a weight ratio up to from 1:4:4 to 1:7:7 dry composition:fat:water.

19. A meat emulsion comprising the dry composition according to claim 2, fat and water in a weight ratio up to 1:5:5 dry composition:fat:water.

20. A method of increasing the functionality of soy protein flour, comprising contacting the soy protein flour with citrus fruit fiber.

21. The method of claim 20, wherein the citrus fruit fiber is dried.

22. The method of claim 20, characterized in that said functionality is increased in processed meat.
